(19) United States
(12) Patent Application Publication
(10) Pub. No.: US 2017/0342918 A1
(43) Pub. Date: Nov. 30, 2017

(54) HYDROCARBON VAPOR CONTROL USING PURGE PUMP AND HYDROCARBON SENSOR TO DECREASE PARTICULATE MATTER

(71) Applicants: Roger C Sager, Munith, MI (US); Jeffrey P Wuttke, Sterling Heights, MI (US); Brett Schubring, Macomb, MI (US); Joseph M Dekar, Jackson, MI (US); James J Daley, Jackson, MI (US); Gregg T Black, Livonia, MI (US)

(72) Inventors: Roger C Sager, Munith, MI (US); Jeffrey P Wuttke, Sterling Heights, MI (US); Brett Schubring, Macomb, MI (US); Joseph M Dekar, Jackson, MI (US); James J Daley, Jackson, MI (US); Gregg T Black, Livonia, MI (US)

(21) Appl. No.: 15/164,470

(22) Filed: May 25, 2016

(51) Int. Cl. F02D 41/00; F02D 41/06; F02M 25/08

(52) U.S. Cl. CPC F02D 41/004; F02M 25/0854; F02D 41/064; F02M 25/0836

(57) ABSTRACT

An evaporative emissions (EVAP) control system for a vehicle includes a purge pump configured to pump fuel vapor to a direct injection (DI) engine of the vehicle via a vapor line and a purge valve and a hydrocarbon (HC) sensor disposed configured to measure an amount of HC in the fuel vapor. The system also includes a controller configured to detect an HC vapor supply condition indicative of an operating condition of the Di engine where engine vacuum is less than an appropriate level for delivering the fuel vapor to the DI engine via the vapor line; and in response to detecting the HC vapor supply condition, controlling at least one of the purge pump and the purge valve, based on the measured amount of HC, to deliver a desired amount of fuel vapor to the DI engine to decrease particulate matter (PM) produced by the DI engine.

### FIELD

The present application generally relates to evaporative emissions (EVAP) control systems and, more particularly, to techniques for utilizing hydrocarbon (HC) vapor to decrease particulate matter produced by a direct injection (DI) engine.

### BACKGROUND

Conventional evaporative emissions (EVAP) control systems include a vapor canister and vapor transport lines. The vapor canister traps fuel vapor that evaporates from liquid fuel (e.g., gasoline) stored in a fuel tank of a vehicle. Engine vacuum is typically utilized to deliver the fuel vapor from the vapor canister to the engine through the vapor transport lines and into intake ports of the engine. When an engine is off (e.g., during engine cold starts), however, there is no engine vacuum.

Similarly, during transient operating periods while the engine is running (e.g., hard acceleration), engine vacuum could fall below a minimum threshold necessary for delivering a desired amount of fuel vapor to the engine. The specific composition or concentration of the fuel vapor is also unknown. Accordingly, while such EVAP control systems work for their intended purpose, there remains a need for improvement in the relevant art.

### SUMMARY

According to a first aspect of the invention, an evaporative emissions (EVAP) control system for a vehicle is presented. In one exemplary implementation, the system includes a purge pump configured to pump fuel vapor trapped in a vapor canister to a direct injection (DI) engine of the vehicle via a vapor line and a purge valve, the fuel vapor resulting from evaporation of a liquid fuel stored in a fuel tank of the DI engine; a hydrocarbon (HC) sensor disposed in the vapor line and configured to measure an amount of HC in the fuel vapor pumped by the purge pump to the DI engine via the vapor line; and a controller configured to: detect an HC vapor supply condition indicative of an operating condition of the DI engine where engine vacuum is less than an appropriate level for delivering the fuel vapor to the DI engine via the vapor line; and in response to detecting the HC vapor supply condition, controlling at least one of the purge pump and the purge valve, based on the measured amount of HC, to deliver a desired amount of fuel vapor to the DI engine, wherein delivery of the desired amount of fuel vapor decreases particulate matter (PM) produced by the DI engine.

According to a second aspect of the invention, a method for controlling a fuel vapor to decrease particulate matter (PM) produce by a direct injection (DI) engine of a vehicle is presented. In one exemplary implementation, the method includes detecting, by a controller of the engine, an HC vapor supply condition indicative of an operating condition of the DI engine where engine vacuum is less than an appropriate level for delivering the fuel vapor from a vapor canister to the DI engine via a vapor line and a purge valve; receiving, by the controller and from a hydrocarbon (HC) sensor disposed in the vapor line, an amount of HC in the fuel vapor pumped a purge pump to the DI engine via the vapor line; and in response to detecting the HC vapor supply condition, controlling, by the controller, at least one of the purge pump and the purge valve, based on the measured amount of HC, to deliver a desired amount of fuel vapor to the DI engine, wherein delivery of the desired amount of fuel vapor decreases particulate matter (PM) produced by the DI engine.

In some implementations, the HC vapor supply condition is further indicative of an operating condition of the DI engine where the DI engine produces PM greater than a PM threshold. In some implementations, the HC vapor supply condition is further indicative of the measured amount of HC being greater than a threshold indicative of a minimum amount of HC for decreasing the PM produced by the DI engine.

In some implementations, the HC vapor supply condition is a transient operating period while the DI engine is running. In some implementations, the transient operating period is an acceleration or torque request greater than a respective threshold corresponding to the engine vacuum falling below the acceptable level for delivering the desired amount of fuel vapor to the DI engine.

In some implementations, the HC vapor supply condition is an imminent cold start of the DI engine. In some implementations, the controller is further configured to: detect a set of cold start preconditions that are each indicative of the imminent cold start of the DI engine; and in response to detecting the set of preconditions, performing the cold start of the DI engine by controlling at least one of the purge pump and the purge valve to deliver the desired amount of fuel vapor to the DI engine. In some implementations, one of the set of cold start preconditions includes (i) a key-on event has occurred that is indicative of an engine-off to engine-on transition, (ii) the purge pump has spooled to greater than a minimum speed threshold, and (iii) the HC sensor is on.

In some implementations, the controller is further configured to command fuel injectors of the DI engine to supply liquid fuel to the DI engine in addition to the desired amount of fuel vapor. In some implementations, the vehicle does not include a gasoline particulate filter (GPF).

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a diagram of an example engine system including an evaporative emissions (EVAP) control system according to the principles of the present disclosure;

FIG. 2 is a functional block diagram of an example configuration of the EVAP control system according to the principles of the present disclosure; and

FIG. 3 is a flow diagram of an example method for controlling fuel vapor to decrease particular matter (PM) produced by a direct injection (DI) engine according to the principles of the present disclosure.

### DETAILED DESCRIPTION

Direct injection (DI) engines tend to produce more particular matter (PM) emissions (e.g., soot) compared to other engines, such as port injection (PI) engines. This is due to liquid fuel (e.g., gasoline) being injected directly into a combustion chamber of a cylinder. Thus, in contrast to PI engines, there is less time for the fuel to vaporize and uniformly mix with the air prior to combustion. Rather, there could be localized fuel rich areas within the combustion chamber due to this quick mixing time. Rich combustion (i.e., fuel rich) is void of excess oxygen, which is necessary to oxidize the PM. To decrease PM emissions, exhaust treatment systems comprising gasoline particulate filter (GPFs) are implemented. These GPFs trap the PM produced by the engine to decrease PM emissions, creating back pressure that could be detrimental to performance and/or fuel economy. GPFs are also expensive and require regeneration (i.e., burning-off of the trapped PM), which results in potential increased system/warranty costs.

Certain operating conditions of the engine tend to produce the highest PM emissions. One example of such an operating condition is a cold start of the engine. During cold starts, the fuel contacts cold cylinder walls and or a top of a piston. During this time, flame quenching could occur and fuel rich areas could occur from the fuel not evaporating correctly. Another example of such an operating condition is a transient engine operating condition, such as hard acceleration, where fuel is more likely to impinge on the piston top. Modified injection timing is often utilized for such transient operating periods. Evaporative emissions (EVAP) control systems are typically configured to deliver fuel vapor (from a fuel tank) that is trapped (in a vapor canister) to an engine via vapor transport lines. Injecting this fuel vapor instead of at least a portion of the liquid fuel provides for a more thorough and even burn in the combustion chamber and thus significantly reduced PM production by the engine. These engine conditions, therefore, are hereafter referred to as “HC vapor supply conditions.”

Conventional EVAP control systems, however, rely upon engine vacuum to deliver fuel vapor. These systems, therefore, may be inoperable for providing fuel vapor to the engine when the engine vacuum is less than an appropriate level for delivering a desired amount of fuel vapor to the engine. Cold starts and transient engine operating periods (e.g., hard acceleration) both correspond to insufficient engine vacuum. Additionally, the specific composition or concentration of (e.g., amount of HC in) the fuel vapor is also unknown, which results in less accurate control. Accordingly, improved EVAP control techniques are presented. The disclosed systems/methods are operable when there is less than a minimum engine vacuum required by conventional EVAP control systems. In one exemplary implementation, the disclosed system includes a purge pump configured to pump fuel vapor that is captured in the vapor canister to the engine and an HC sensor for measuring an amount of HC in the fuel vapor pumped by the purge pump. By utilizing such a system, the engine could implement a smaller GPF or no GPF at all (and its corresponding hardware, such as sensors).

By implementing the purge pump and the HC sensor, the disclosed EVAP control techniques are configured to supply the engine with a desired amount of fuel vapor corresponding to a desired amount of HC. This is particularly useful, for example, during engine-off periods (e.g., engine cold starts) and engine transient operation periods (e.g., hard acceleration) where engine vacuum is insufficient for supplying the fuel vapor to the engine. Another benefit is improved/faster catalyst light-off by heating up exhaust treatment components more quickly. The phrase catalyst light-off refers to a temperature at which a catalyst begins to actively react with exhaust gas in order to decrease emissions. Thus, one specific control technique involves controlling the purge pump based on measurements from the HC sensor to supply the engine with the desired amount of fuel vapor during these engine operating periods to achieve the objective of decreased PM emissions.

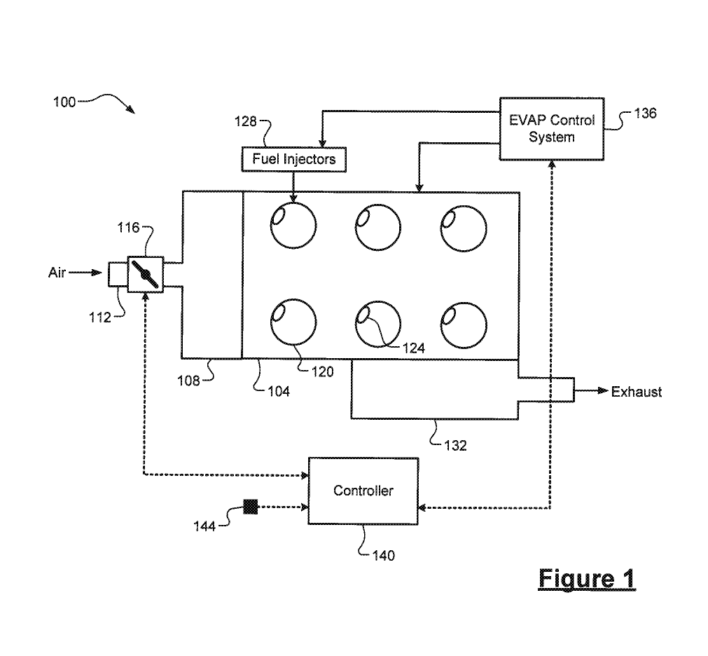

Referring now to FIG. 1, an example engine system 100 is illustrated. The engine system 100 includes an engine 104 that is configured to combust an air/fuel mixture to generate drive torque. The engine draws air into an intake manifold 108 through an induction system 112 that is regulated by a throttle valve 116. The air in the intake manifold 108 is distributed to a plurality of cylinders 120 via respective intake ports 124. While six cylinders are shown, the engine 104 could have any number of cylinders. Fuel injectors 128 are configured to inject liquid fuel (e.g., gasoline) directly into the cylinders 120 of the engine 104 (direct fuel injection). While not shown, it will be appreciated that the engine 104 could include other components, such as a boost system (supercharger, turbocharger, etc.).

Intake valves (not shown) control the flow of the air or air/fuel mixture into the cylinders 120. The air/fuel mixture is compressed by pistons (not shown) within the cylinders 120 and combusted (e.g., by spark plugs (not shown)) to drive the pistons, which rotate a crankshaft (not shown) to generate drive torque. Exhaust gas resulting from combustion is expelled from the cylinders 120 via exhaust valves/ports (not shown) and into an exhaust treatment system 132. The exhaust treatment system 132 treats the exhaust gas before releasing it into the atmosphere. An EVAP control system 136 selectively provides fuel vapor to the engine 104 via the intake ports 124. While delivery via the intake ports 124 is shown and discussed herein, it will be appreciated that the fuel vapor could be delivered to the engine 104 directly into the cylinders 120.

The EVAP control system 136 includes at least a purge pump (not shown) and an HO sensor (not shown). The EVAP control system 136 is controlled by a controller 140. The controller 140 is any suitable controller or control unit for communicating with and commanding the EVAP control system 136. In one exemplary implementation, the controller 140 includes one or more processors and a non-transitory memory storing a set of instructions that, when executed by the one or more processors, cause the controller 140 to perform a specific fuel vapor delivery technique. The controller 140 is configured to receive information from one or more vehicle sensors 144. Examples of the vehicle sensors 144 include an ambient pressure sensor, an altitude or barometric pressure sensor, an engine coolant temperature sensor, a key-on sensor, and an torque request sensor, such as an accelerator pedal position sensor.

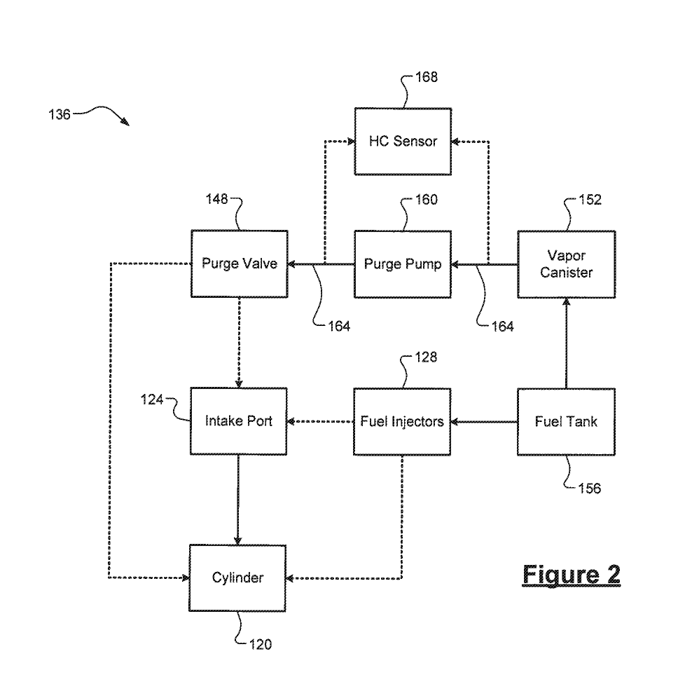

Referring now to FIG. 2, a functional block diagram of an example configuration of the EVAP control system 136 is illustrated. While the EVAP control system 136 is only shown with respect to a single intake port 124 and single cylinder 120 of the engine 104, it will be appreciated that the fuel vapor could be supplied to all of the intake ports 124 and/or cylinders 120. The EVAP control system 136 is configured to deliver fuel vapor to the intake ports 124 of the engine 104 via purge valves 148. For example, the purge valves 148 could be disposed within holes or apertures in a wall of the intake ports 124. As previously mentioned, it will be appreciated that the purge valves 148 could be configured to deliver the fuel vapor directly to the cylinders 108, e.g., via different holes or apertures. One example of the purge valves is a butterfly-type valve, but it will be appreciated that any suitable valve configured to regulate the flow of pressurized fuel vapor could be utilized.

The EVAP control system 136 includes a vapor canister 152 that traps fuel vapor that evaporates from liquid fuel stored in a fuel tank 156. This fuel vapor can be directed from the fuel tank 156 to the vapor canister via an evaporation line or duct 154. In one exemplary implementation, the vapor canister includes (e.g., is lined with) activated carbon (e.g., charcoal) that adsorbs the fuel vapor. While not shown, the vapor canister 152 could further include a vent device (e.g., a valve) that allows fresh air to be drawn through the vapor canister 152, thereby pulling the trapped fuel vapor with it. As previously discussed, conventional EVAP control systems utilize engine vacuum to draw this fresh air (and trapped fuel vapor) through the system for engine delivery.

In the illustrated EVAP control system 136, a purge pump 160 is configured to selectively pump the fuel vapor from the vapor canister 152 through vapor lines 164 to the intake ports 124 (via the purge valves 148). This pumping could be in conjunction with or without the use of drawn fresh air through the vapor canister 152. The purge pump 160 could be any suitable pump configured to pump the fuel vapor from the vapor canister 152 through vapor lines 164. An HC sensor 168 is disposed in the vapor lines 164 and configured to measure an amount of HC in the fuel vapor pumped by the purge pump 160. As shown, the HC sensor 168 could measure the amount of HC flowing into and/or out of the purge pump 160. The measured amount of HC is indicative of an amount of the fuel vapor that is combustible. Rather, the HC in the fuel vapor represents the highly combustible component of the fuel vapor.

As the purge valves 148 regulate the flow of the fuel vapor into the engine 104, the controller 140 is configured to control at least one of the purge pump 160 and the purge valves 148 to deliver the desired amount of fuel vapor to the engine 104. The control of the purge pump 160 could include controlling its rotational speed. The control of the purge valves 148, on the other hand, could include controlling their angular opening. For example, there may be a high amount of HC present in highly pressurized fuel vapor in the vapor lines 164, and thus the controller 148 may primarily actuate the purge valves 148 to deliver the desired amount of fuel vapor. In many situations, however, the controller 160 will perform coordinated control of both the purge pump 160 and the purge valves 148 to deliver the desired amount of fuel vapor (e.g., a desired amount of HC) to the engine 104.

By delivering this highly combustible fuel vapor to the engine 104, combustion improves and emissions decrease. As previously discussed, the controller 140 is also configured to control the fuel injectors 128 to deliver the liquid fuel from the fuel tank 156 to the engine 104. This liquid fuel injection could be either port fuel injection or direct fuel injection. In one exemplary implementation, the controller 140 is further configured to control the fuel injectors 128 to deliver the liquid fuel from the fuel tank 156 after a period of controlling at least one of the purge pump 160 and the purge valves 148 to deliver the desired amount of fuel vapor to the engine 104. This period, for example only, could be a cold start of the engine 104.

Various preconditions and combinations thereof could be implemented for operating the EVAP control system 136. In one exemplary implementation, the controller 140 is configured to control at least one of the purge pump 160 and the purge valves 148 based on a measured ambient temperature. Another exemplary precondition is detecting a key-on event of the vehicle. For example, these preconditions could be indicative of a cold start of the engine 104. Other exemplary preconditions could also be utilized, such as the rotational speed of the purge pump 160 reaching a desired level (e.g., where adequate pumping can occur) and the HC sensor 168 being turned on. Another exemplary precondition could include the MC sensor 168 measuring an amount of HC greater than a minimum threshold for combustion by the engine 104. In other words, if there is too little HC in the fuel vapor, there could be no combustion benefit by delivering the fuel vapor to the engine 104.

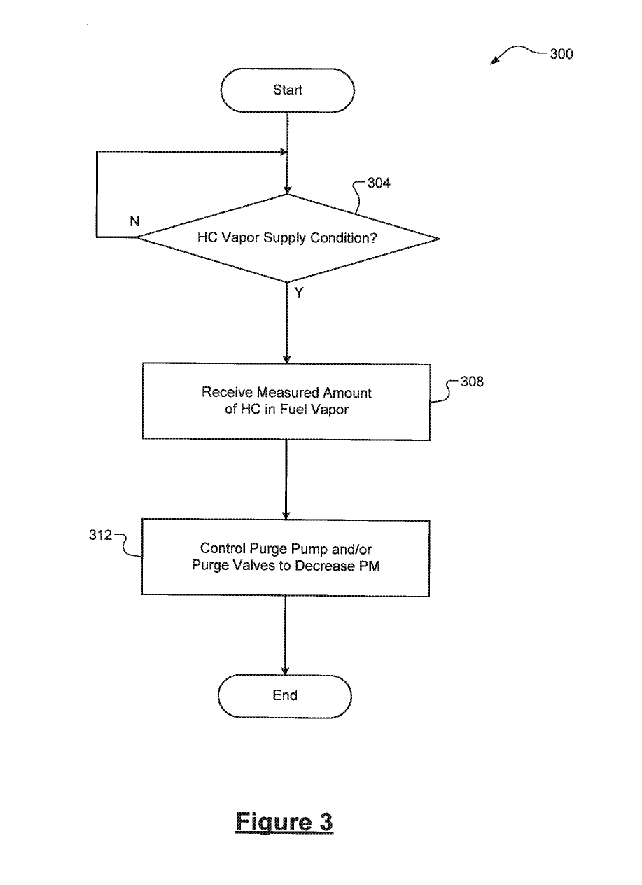

Referring now to FIG. 3, an example method 300 for controlling fuel (HC) vapor to decrease PM emissions of the DI engine 104 is presented. At 304, the controller 140 detects whether the HC vapor supply condition is present. As discussed herein, non-limiting examples of this condition include an imminent cold start of the DI engine 104 and a transient operating period of the DI engine 104, such as hard acceleration. The term “transient” and the phrases “transient operating condition” and “transient operating period as used herein refer to engine-on periods where a torque request from a driver is greater than a steady-state condition. This is also described herein as “hard acceleration” and could refer to an accelerator pedal position (from sensor 144) being greater than a threshold. While high torque (e.g., hard acceleration) transient operating periods are discussed herein, it will be appreciated that other fuel vapor could be supplied to the DI engine 104 in other transient operating periods where there is little or no engine vacuum.

When the HC vapor supply condition is detected at 304, the method 300 proceeds to 308. Otherwise, the method 300 ends or returns to 304. At 308, the controller 140 receives, from the HC sensor 168, an amount of HC in the fuel vapor pumped the purge pump 160 to the DI engine via the vapor line 164. At 312, the controller 140 controls at least one of the purge pump 160 and the purge valve 148, based on the measured amount of HC, to deliver a desired amount of fuel vapor to the DI engine 104. Delivery of the desired amount of fuel vapor decreases PM produced by the DI engine. In one exemplary implementation, controlling the purge pump 160 involves controlling its rotational speed and controlling the purge valve 148 involves controlling its opening angle. This is because a flow rate of the fuel vapor is dependent on these two parameters: pump speed and valve opening angle. The method 300 then ends or returns to 304 for one or more additional cycles.

Modern GPFs typically have a complex design and are typically made from various materials including a porous ceramic material, silicon carbine, or metal fibers. This complex design and material composition makes GPFs very expensive. Monitoring the load of the GPFs and then performing regeneration (active, passive, or forced) is also very complex and costly to implement. By mitigating PM produced by the DI engine 104 via the supply of fuel vapor from the EVAP system 136, a GPF of the exhaust treatment system 132 could potentially be eliminated. If eliminated, related componentry (e.g., temperature and/or pressure sensors) in the exhaust treatment system 132 could also be eliminated. Further, the controller 140 would not have to implement a regeneration control strategy for the GPF, which reduces the complexity of the controller 140. Even if the GPF could not be eliminated, its size could be reduced, which could also save costs.

As previously discussed, it will be appreciated that the term “controller” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

It should be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

1. An evaporative emissions (EVAP) control system for a vehicle, the system comprising:
a purge pump configured to pump fuel vapor trapped in a vapor canister to a direct injection (DI) engine of the vehicle via a vapor line and a purge valve, the fuel vapor resulting from evaporation of a liquid fuel stored in a fuel tank of the DI engine;
a hydrocarbon (HC) sensor disposed in the vapor line and configured to measure an amount of HC in the fuel vapor pumped by the purge pump to the DI engine via the vapor line; and
a controller configured to:
detect an HC vapor supply condition indicative of an imminent cold start of the DI engine; and
in response to detecting the HC vapor supply condition:
determine a desired amount of fuel vapor to deliver to the DI engine to decrease particulate matter (PM) produced by the DI engine to a desired level; and
control at least one of the purge pump and the purge valve, based on the measured amount of HC, to deliver the desired amount of fuel vapor to the DI engine.

2. The system of claim 1, wherein the HC vapor supply condition is further indicative of an operating condition of the DI engine where the DI engine produces PM greater than a PM threshold.

3. The system of claim 1, wherein the HC vapor supply condition is further indicative of the measured amount of HC being greater than a threshold indicative of a minimum amount of HC for decreasing the PM produced by the DI engine.

4-6. (canceled)

7. The system of claim 1, wherein the controller is further configured to:
detect a set of cold start preconditions that are each indicative of the imminent cold start of the DI engine; and
in response to detecting the set of preconditions, performing the cold start of the DI engine by controlling at least one of the purge pump and the purge valve to deliver the desired amount of fuel vapor to the DI engine.

8. The system of claim 7, wherein one of the set of cold start preconditions includes (i) a key-on event has occurred that is indicative of an engine-off to engine-on transition, (ii) the purge pump has spooled to greater than a minimum speed threshold, and (iii) the HC sensor is on.

9. The system of claim 1, wherein the controller is further configured to command fuel injectors of the DI engine to supply liquid fuel to the DI engine in addition to the desired amount of fuel vapor.

10. The system of claim 1, wherein the vehicle does not include a gasoline particulate filter (GPF).

11. A method for controlling a fuel vapor to decrease particulate matter (PM) produce by a direct injection (DI) engine of a vehicle, the method comprising:
detecting, by a controller of the engine, an HC vapor supply condition indicative of a transient acceleration period of the vehicle;
receiving, by the controller and from a hydrocarbon (HC) sensor disposed in the vapor line, an amount of HC in the fuel vapor pumped a purge pump from a vapor canister to the DI engine via a vapor line; and
in response to detecting the HC vapor supply condition:
determining, by the controller, a desired amount of fuel vapor to deliver to the DI engine to decrease particulate matter (PM) produced by the DI engine to a desired level; and
controlling, by the controller, at least one of the purge pump and a purge valve, based on the measured amount of HC, to deliver the desired amount of fuel vapor to the DI engine.

12. The method of claim 11, wherein the HC vapor supply condition is further indicative of an operating condition of the DI engine where the DI engine produces PM greater than a PM threshold.

13. The method of claim 11, wherein the HC vapor supply condition is further indicative of the measured amount of HC being greater than a threshold indicative of a minimum amount of HC for decreasing the PM produced by the DI engine.

14. (canceled)

15. The method of claim 11, wherein the transient acceleration period is an acceleration or torque request greater than a respective threshold corresponding to engine vacuum falling below an acceptable level for delivering the desired amount of fuel vapor to the DI engine.

16-18. (canceled)

19. The method of claim 11, further comprising commanding, by the controller, fuel injectors of the DI engine to supply liquid fuel to the DI engine in addition to the desired amount of fuel vapor.

20. The method of claim 11, wherein the vehicle does not include a gasoline particulate filter (GPF).
